(19) United States
(12) Patent Application Publication
(10) Pub. No.: US 2010/0319213 A1
(43) Pub. Date: Dec. 23, 2010

(54) HOT AIR GENERATING APPARATUS AND DRYER HAVING THE SAME

(76) Inventors: Yang-Ho Kim, Gyeongsangnam-Do (KR); Seung-Phyo Ahn, Gyeongsangnam-Do (KR); Sang-Ik Lee, Gyeongsangnam-Do (KR); Byeong-Jo Ryoo, Gyeongsangnam-Do (KR); Sung-Ho Song, Gyeongsangnam-Do (KR); Han-Yong Jung, Gyeongsangnam-Do (KR); Jae-Hyuk Wee, Gyeongsangnam-Do (KR); Yoon-Seob Eom, Gyeongsangnam-Do (KR)

Correspondence Address: BIRCH STEWART KOLASCH & BIRCH, PO BOX 747, FALLS CHURCH, VA, 22040-0747, US

(21) Appl. No.: 12/526,405

(22) PCT Filed: Feb. 5, 2008
(86) PCT No.: PCT/KR08/00712

§ 371 Date: Aug. 7, 2009

(30) Foreign Application Priority Data
Feb. 8, 2007 (KR) 10-2007-0013387
Feb. 13, 2007 (KR) 10-2007-0015003

(51) Int. Cl. F26B 21/02; F26B 21/10; D06F 58/04

(52) U.S. Cl. 34/565; 34/132

(57) ABSTRACT

The present invention relates to a hot air generating apparatus and a dryer having the same. The hot air generating apparatus comprises a temperature sensing unit, and a gas supply unit controlling a flowing amount of gas to be supplied according to a temperature of hot air sensed by the temperature sensing unit, wherein when the temperature of the hot air sensed by the temperature sensing unit approaches a pre-set threshold value, the flowing amount of gas to be supplied is gradually reduced, thereby being capable of continuously supplying hot air without being frequently turned on/off.

### TECHNICAL FIELD

The present invention relates to a dryer, and more particularly, to a hot air generating apparatus which is capable of continuously supplying hot air by sensing a temperature and an air volume of the hot air using a thermistor, and then controlling flowing amount of gas to be supplied according to the sensed temperature and the air volume using a linear valve, and a dryer having the same.

### BACKGROUND ART

Generally, a clothes dryer is an apparatus performing a drying operation on objects such as wet laundry to be dried by blowing hot air generated by a heater into a drum to absorb moisture from the objects therewithin. Dryers can be categorized as exhausting type dryers and condensing type dryers depending on the method employed for dealing with the humid air generated as the objects are dried by absorbing moisture therefrom.

In the exhausting type dryer, humid air exhausted from a drum is exhausted outside the dryer. However, an exhaust duct is required for exhausting the moisture evaporated from the objects in the drum to the outside of the dryer, and especially, the exhaust duct should be installed being extended a long distance to the outside of a room or building, because products of combustion such as carbon monoxide etc. are exhausted together with the moisture.

Meanwhile, in the condensing type dryer, the moisture in the humid air exhausted from the drum is condensed at a heat exchange unit to remove the moisture therefrom, and the dried air is recirculated back into the drum. However, a condensing type dryer does not facilitate to use gas as a heating source because a closed loop may be formed due to the flowing of the drying air.

In a ductless dryer, these disadvantages of the exhausting type and the condensing type dryers may be improved upon. That is, the ductless dryer can use gas as its heating source, and accordingly it can be maintained inexpensively, although it is required to have an additional exhaust duct installed to be extended a long distance to the outside of the room.

In the ductless dryer, since gas is used as the heating source, it is required to provide a safety device for preventing the dryer from being overheated. The safety device includes a thermostat sensing a temperature of hot air generated by heating external air using a flame generated by igniting the gas, and a gas valve by which a flowing amount of gas to be supplied is controlled according to the temperature of the hot air sensed by the thermostat. The gas valve is implemented as an on/off valve.

In the related ductless dryer, on igniting an igniter, the gas valve is turned on and the flame is ignited. During the operation, when the temperature of the thermostat reaches a specific threshold value, the system is recognized as in an unstable state, accordingly the gas valve is turned off.

However, it is frequently occurs that the temperature of the thermostat increases during the operation of the dryer and then the gas valve is turned on/off. Thus, a drying efficiency of the dryer is deteriorated. And, a power consumption increases due to the frequent on/off operations.

### DISCLOSURE OF THE INVENTION

### Technical Problem

Therefore, it is an object of the present invention to provide a hot air generating apparatus which is capable of continuously supplying hot air and of reducing a power consumption by controlling a flowing amount of gas to be supplied, using a linear valve, and a dryer having the same.

Further, it is another object of the present invention to provide a hot air generating apparatus which is capable of dealing with variation of a load and clogging of a lint filter, and a dryer having the same.

### Technical Solution

To achieve these objects, there is provided a hot air generating apparatus comprising a temperature sensing unit and a gas supply unit controlling a flowing amount of gas to be supplied according to a temperature of hot air sensed by the temperature sensing unit, wherein when the temperature of the hot air sensed by the temperature sensing unit approaches a pre-set threshold value, the flowing amount of gas to be supplied is gradually reduced.

With such configuration, an on/off operation for gas supply by the gas supply unit does not frequently occur, accordingly it is capable of continuously supplying the hot air.

The temperature sensing unit may be installed at a funnel encompassing one end of a mixing pipe in which the supplied gas is mixed with air by being connected to the gas supply unit. The temperature sensing unit may be installed at the funnel so as to be adjacent to an igniter connected to one end of the mixing pipe. Since a flame is generated and the hot air is supplied in the funnel, and the temperature of the hot air is the highest at a periphery of the igniter, in the hot air generating apparatus, the temperature sensing unit should be installed at the abovementioned position so as to precisely sense the temperature of the hot air.

The temperature sensing unit may be implemented as a thermistor. A thermostat formed by a bi-metal breaks a circuit when the temperature reaches a specific value. However, the thermistor controls the temperature using variation of a resistance value according to variation of the temperature, accordingly an abrupt breaking of the circuit does not frequently occur.

Effectively, the gas supply unit may be implemented as a linear valve that can consecutively adjust the gas supply amount, and the linear valve may be implemented as a solenoid. The linear valve switched by linearly moving a passage for supplying gas can gradually and consecutively control the flowing amount of gas to be supplied, accordingly the gas supply is not stopped, but the flowing amount of gas is reduced even when the temperature sensed by the temperature sensing unit approaches the threshold value, thereby being capable of preventing a system from being frequently turned on/off.

The hot air generating apparatus may further comprise a micom receiving the temperature of the hot air sensed by the temperature sensing unit and controlling the flowing amount of gas to be supplied from the gas supply unit when the temperature approaches the threshold value.

Meanwhile, in accordance with one embodiment of the present invention, there is provided a dryer comprising a main body, a drum rotatably installed at the main body, a hot air generating apparatus for providing hot air into the drum, a heat exchange unit for removing moisture contained in air exhausted from the drum, and an exhaust unit dispersively exhausting the air flowing out of the heat exchange unit in a rear direction of the main body, wherein the hot air generating apparatus may comprise a gas supply unit gradually reducing a flowing amount of gas to be supplied when the temperature of the hot air sensed by a temperature sensing unit approaches a threshold value. The temperature sensing unit may be installed at a funnel encompassing one end of a mixing pipe in which the supplied gas is mixed with air by being connected to the gas supply unit, or at a connect portion connecting a hot air supply duct with the drum.

Further, in accordance with another embodiment of the present invention, there is provided a dryer comprising a main body, a drum rotatably installed at the main body, a hot air generating apparatus for providing hot air into the drum, a heat exchange unit for removing moisture contained in the air exhausted from the drum, and an exhaust unit dispersively exhausting the air flowing out of the heat exchange unit in a rear direction of the main body, wherein the hot air generating apparatus may comprise a gas supply unit gradually reducing a flowing amount of gas to be supplied when an air volume sensed by an air volume sensing unit approaches a threshold value. The air volume sensing unit may be installed at a connect portion connecting a hot air supply duct with the drum.

### BRIEF DESCRIPTION OF THE DRAWINGS

FIG. 1 is a sectional view showing a condensing type dryer in accordance with one embodiment of the present invention;

FIG. 2 is a planar view showing an interior of the dryer of FIG. 1;

FIG. 3 is an extracted view of an exhaust unit and a hot air supplying apparatus of the dryer of FIG. 1;

FIG. 4 is a sectional view showing an exhausting type dryer having a hot air supplying apparatus in accordance with another embodiment of the present invention;

FIG. 5 is a sectional view showing a condensing type dryer in accordance with another embodiment of the present invention; and

FIG. 6 is a sectional view showing a condensing type dryer having an air volume sensing unit in accordance with another embodiment of the present invention.

### MODES FOR CARRYING OUT THE PREFERRED EMBODIMENTS

Description will now be given in detail of the preferred embodiment of the present invention, examples of which are illustrated in the accompanying drawings.

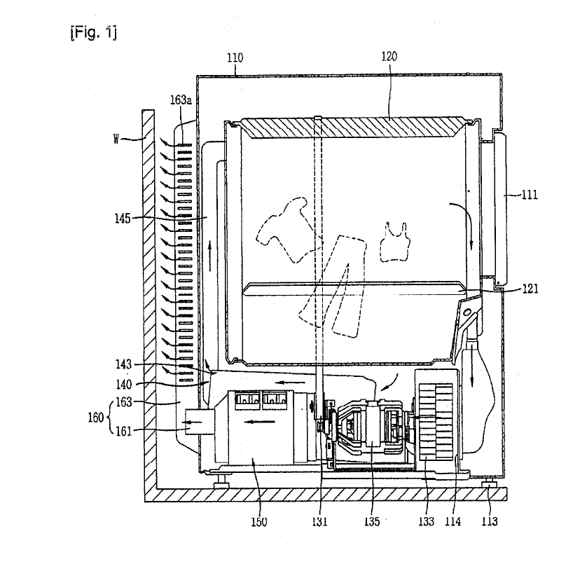

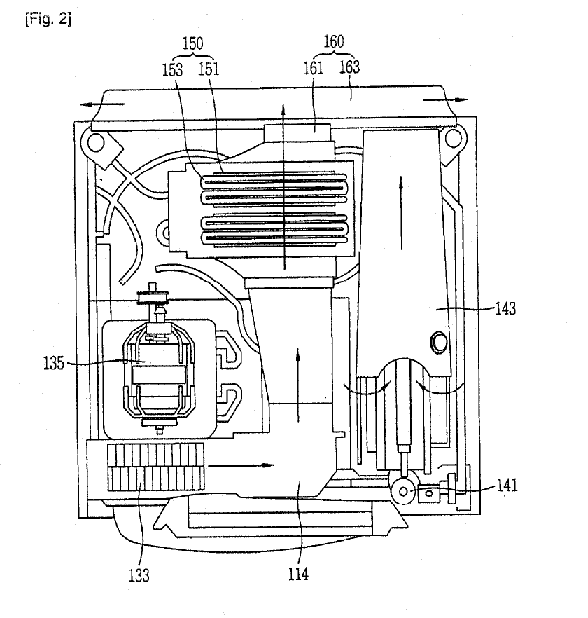

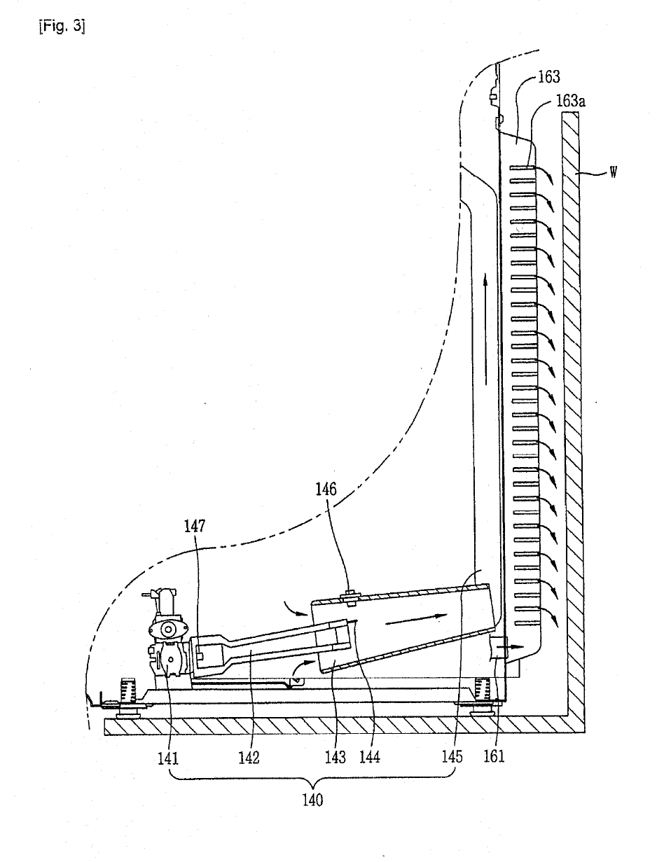

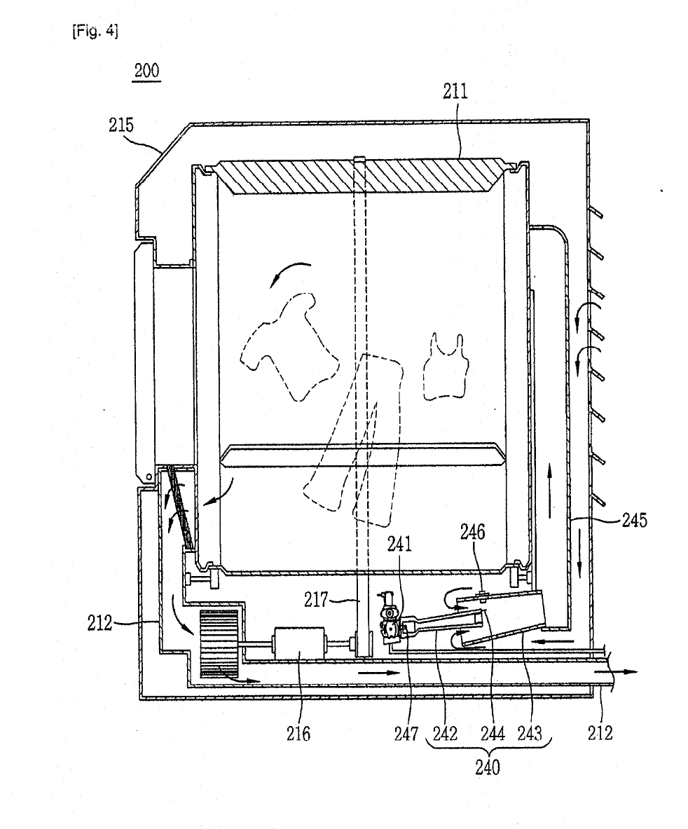

FIG. 1 is a sectional view showing a condensing type dryer in accordance with one embodiment of the present invention, FIG. 2 is a planar view showing an interior of the dryer of FIG. 1, FIG. 3 is an extracted view of an exhaust unit and a hot air supplying apparatus of the dryer of FIG. 1, and FIG. 4 is a sectional view showing an exhausting type dryer having a hot air supplying apparatus in accordance with another embodiment of the present invention.

As shown in FIGS. 1 and 2, the condensing type dryer in accordance with one embodiment of the present invention includes a main body 110, a drum 120 rotatably installed at the main body 110, a hot air generating apparatus 140 providing hot air into the drum 120, a heat exchange unit 150 for removing moisture contained in air exhausted from the drum, and an exhaust unit 160 dispersively exhausting the air flowing out of the heat exchange unit 150 in a rear direction of the main body 110.

A door 111 for putting clothes into the drum 120 is installed at a front side of the main body 110. And, a foot 113 supporting the main body 110 is installed at a lower side of the main body 110. The main body 110 has an inner space provided with a belt 131 rotating the drum 120, a fan 133 installed in a circulation duct 114, for providing a blowing force for air in the ductless dryer and a motor 135 providing the belt 131 and the fan 133 with a driving force.

Here, the motor 135 may be configured to be plural so as to provide the belt 131 and the fan 133 with the driving force, respectively. And, the circulation duct 114 is provided with a lint filter (not shown) for filtering lint such as a fluff and a waste thread contained in hot and humid air flowing out of the drum 120.

The drum 120 is a container having an inner space for objects to be dried, such as clothes. A plurality of lifters 121 for lifting the clothes are installed therein.

The heat exchange unit 150 is composed of a fin 151 and a tube 153. In the heat exchange unit 150, hot and humid air flowing out of the drum 120 is condensed by low-temperature water and dried by a heat exchanging manner between air and water. The heat exchange unit 150 has an inlet connected to the drum 120 by the circulation duct 114 and an outlet connected to an exhaust duct 161.

The fin 151 is implemented as a plurality of thin plates stacked to each other with a minute gap therebetween so as to pass through the hot and humid air by vertically contacting thereto. Here, the thin plate is formed by a metallic material having an excellent conductivity.

The low-temperature (22° C.) water is circulated in the tube 153. And, the tube 223 is penetratingly formed at the fin 221 in a reciprocating manner. The tube 153 has both lateral ends connected to a water hose (not shown) through which the low-temperature water is supplied and collected. A water container (not shown) for collecting condensed water generated in a condensing process and dropping is provided at the lower portion of the heat exchange unit 150.

The exhaust unit 160 has one end connected to the heat exchange unit 150 and another end provided with the exhaust duct 161 exposed toward the rear side of the main body 110 and a back cover 163 covering the exposed exhaust duct 161, for exhausting the exhausted air through a lateral surface.

A plurality of sleets 163a are formed at the lateral surface of the back cover 163. The sleets 163a are formed by boring holes through the back cover 163, and the air is exhausted through the sleets 163a in a lateral direction, a direction of arrows. The sleets 163a may be formed at an upper surface, a rear surface or a lower surface, besides the lateral surface, if necessary.

Since there is no additional exhaust duct exposed to the outside by being connected to the back cover 163, the dryer in accordance with the present invention is a ductless dryer. And, since the humid air after the drying process is processed using the heat exchange unit 150, the dryer in accordance with the present invention is a condensing type ductless dryer.

As a detailed configuration, since the air flowing out of the exhaust unit 160 is dispersively exhausted in the lateral direction, the direction of arrows, even when the dryer is mounted on a wall (W) so as for the exhaust unit 160 installed at the rear side of the dryer to face the wall (W), the air does not resist the wall (W) directly, accordingly an exhaust resistance of the air is reduced.

Accordingly, the air facilitates to flow in the entire dryer, thereby enhancing a drying performance. And, since the dryer is mounted on the wall (W) so as for the exhaust unit 160 installed at the rear side of the dryer to face the wall (W), an installation space may be reduced, thereby increasing a space utilization degree.

Further, in the dryer provided with the heat exchange unit operated by the heat exchanging manner between air and water, exhaust air is managed to have a temperature of approximately 30° C. The exhaust air is exhausted in the lateral direction of the dryer, accordingly the exhaust air is uniformly distributed to the rear side of the dryer. Accordingly, a cooling operation is performed at a large area of the rear side of the dryer, thereby rapidly performing the entire cooling operation for the dryer.

Meanwhile, as shown in FIG. 3, the hot air generating apparatus 140 includes a gas supply unit 141 controlling the flowing amount of gas to be supplied, a mixing pipe 142 in which the gas supplied from the gas supply unit 141 is mixed with an external air, an igniter 144 igniting the gas and air mixed in the mixing pipe 142 so as to generate a flame, and a funnel 143 forming a space for generating hot air.

The hot air generating apparatus 140 will be described in detail. The hot air generating apparatus 140 includes the mixing pipe 142 in which the gas exhausted from the gas supply unit 141 is mixed with the external air by having one end connected to the gas supply unit 141, the igniter 144 igniting the mixed gas exhausted through an outlet of the mixing pipe 142 by being installed at another end of the mixing pipe 142, and the funnel 143 for supplying the hot air generated by a combustion of the gas to a hot air supply duct 145 by being disposed at the outlet of the mixing pipe 142 and connected to an inlet of the hot air supply duct 145.

Here, an injection nozzle 147 for injecting the gas is installed at the gas supply unit 141. And, a suction portion of the mixing pipe 142 is connected to the injection nozzle 147 and a discharge portion of the mixing pipe 142 has an end portion inserted into a suction portion of the funnel 143.

In the hot air generating apparatus 140 connected to the gas supply unit 141, the gas supplied from the gas supply unit 141 is mixed with the external air and ignited, accordingly heat is generated. And, the heat is used to heat air. The hot air generated by the heating process is provided to the drum 120 through the hot air supply duct 145.

Here, the mixing pipe 142 in which the gas, fuel, is mixed with air has one side provided with the injection nozzle 147 for injecting the gas supplied from the gas supply unit 141 to the mixing pipe 142 and another side at which a flame holder (not shown) for controlling exhausting-out of the flame generated from the mixing pipe 142.

Meanwhile, the hot air generating apparatus 140 may be provided with a flame rod (not shown) extended from an edge portion of the flame so as to detect a flame current and indirectly measure the amount of carbon monoxide (CO) through a value of the flame current.

The hot air generating apparatus 140 is provided with a safety device. The safety device includes the gas supply unit 141 controlling the flowing amount of gas to be supplied to the mixing pipe 142, and a temperature sensing unit 146 attached at the funnel 143 encompassing the mixing pipe 142 connected to the gas supply unit 141.

Here, preferably, a linear valve that can consecutively adjust a gas supply amount is used for the gas supply unit 141, and implemented as a solenoid valve. The solenoid valve is operated by an electromagnetic principle, and a linear motor that linearly reciprocates is applied thereto, thus it is capable of gradually reducing an area of a passage for gas as well as opening/closing the passage.

Since the linear valve is implemented as the solenoid valve, an opened degree of the valve can be properly controlled by strength of a current supplied to the solenoid valve, thereby being capable of preventing abrupt turning on/off for gas supply.

Also, the temperature sensing unit 146 is installed in the funnel 143, effectively, at a position where the temperature of the hot air generated therein is the highest. The outlet of the mixing pipe 142 and the igniter 144 installed at the outlet are disposed in the funnel 143. Preferably, the temperature sensing unit 146 is installed to be adjacent to the igniter 144 because the temperature of the hot air is relatively high at the periphery of the igniter 144.

Further, the temperature sensing unit may be installed at a connect portion 145a connecting the hot air supply duct 145 with the drum 120.

Here, a thermistor, a semiconductor device for detecting a temperature is used for the temperature sensing unit 146. The thermistor has a negative temperature coefficient meaning that the higher the temperature is, the lower a resistance value.

Using the thermistor that has drastically variable resistance even when the temperature is minutely varied due to a small thermal capacity, as the temperature sensing unit 146, it is capable of measuring the temperature more precisely.

A micom (not shown) is further installed. The micom serves to control the flowing amount of gas by transmitting a controlling signal to the gas supply unit 141 based on the temperature of the hot air sensed by the temperature sensing unit 146. Preferably, the micom is installed in the main body 110.

Meanwhile, the hot air generating apparatus 140 may be applied to an exhausting type dryer as well as the condensing type dryer. FIG. 4 shows the exhausting type dryer having the hot air generating apparatus 240 in accordance with the present invention, including a hot air supply duct 245 installed to supply hot air into a drum 211, a gas supply unit 241 consecutively controlling the flowing amount of gas to be supplied, and a hot air generating apparatus 240 supplying hot air to the duct by igniting the gas exhausted from the gas supply unit 241.

Here, the drum 211 is rotatably installed in the main body 215. A driving unit is installed to rotate the drum 211. The driving unit is mainly operated by an indirect driving manner, including a motor 216 generating a driving force and a belt 217 rotating the drum 211 by receiving the driving force of the motor 216.

An exhaust duct 212 by which hot air generated by the hot air generating apparatus 240 is introduced into the drum 211 and exhausted to the outside together with moisture contained in wet laundry. Since the moisture is exhausted out, the exhaust duct 212 is not required for having an additional heat exchanger for collecting the moisture from the hot air.

A configuration of the hot air generating apparatus 240 shown in FIG. 4 is same as that of FIG. 1. That is, the hot air generating apparatus 240 includes a mixing pipe 242 in which the gas exhausted from the gas supply unit 241 is mixed with the external air by having one end connected to the gas supply unit 241, an igniter 244 igniting the mixed gas exhausted through an outlet of the mixing pipe 242 by being installed at another end of the mixing pipe 242, and a funnel 243 for supplying the hot air generated by the combustion of the gas to the hot air supply duct 245 by being disposed at the outlet of the mixing pipe 242 and connected to an inlet of the hot air supply duct 245.

Here, an injection nozzle 247 for injecting the gas is installed at the gas supply unit 241. And, a suction portion of the mixing pipe 242 is connected to the injection nozzle 247 and a discharge portion of the mixing pipe 242 has an end portion inserted into a suction portion of the funnel 243.

In the hot air generating apparatus 240 connected to the gas supply unit 241, the gas supplied from the gas supply unit 241 is mixed with the external air and ignited, accordingly heat is generated. And, the heat is used to heat air. The hot air generated by the heating process is provided to the drum 211 through the hot air supply duct 245.

Here, effectively, a linear valve which is capable of reducing a sectional area of a gas passage as well as opening or closing the gas passage is applied to the gas supply unit 241, and the linear valve is implemented as a solenoid valve operated by the electromagnetic principle.

Also, a temperature sensing unit 246 is installed a funnel 243 so as to be adjacent to the igniter 244. The thermistor is used for the temperature sensing unit 246.

Hereafter, an operation of the dryer having the hot air generating apparatus in accordance with one embodiment of the present invention will be described.

In the hot air generating apparatus 143, the gas supplied from the gas supply unit 141 is mixed with the external air and ignited so that hot air is generated. The hot air is supplied into the drum 120 through the hot air supply duct 145. The supplied hot air is used to dry objects to be dried, such as clothes in the drum 120.

The air becomes hot and humid resulting from drying the objects after being supplied into the drum 120. And, the hot and humid air is exhausted through the circulation duct 114. Lint such as a fluff and a waste thread contained in the hot and humid air exhausted from the drum 120 is collected and removed by passing through a lint filter (not shown) installed on the circulation duct 114. And, the hot and humid air not containing the lint is forcedly circulated to the heat exchange unit 150.

The hot and humid air passes through the fin 151 of the heat exchange unit 150 by vertically contacting thereto so that the hot and humid air is condensed and thus becomes to dry air. Condensed water generated in the condensing process and dropping is collected in a water container (not shown).

In this process, in order to safely operate the system, a threshold temperature value is inputted to the micom (not shown) in advance. The threshold temperature value is 85±5° C. The temperature of the hot air sensed by the temperature sensing unit 146 is transmitted to the micom in the process of generating hot air using the mixed air by igniting the gas in the hot air generating apparatus 140.

When the temperature transmitted to the micom approaches the threshold value, 85±5° C., a signal is transmitted from the micom to the gas supply unit 141 so that the flowing amount of gas is controlled. In case that the gas supply unit 141 is implemented as the linear valve, the linear valve is moved by the signal transmitted from the micom, accordingly the area of the gas passage is reduced, thereby reducing the flowing amount of gas to be supplied.

Accordingly, it is capable of preventing the hot air generating apparatus 140 from being frequently turned on/off during the drying cycle of the dryer.

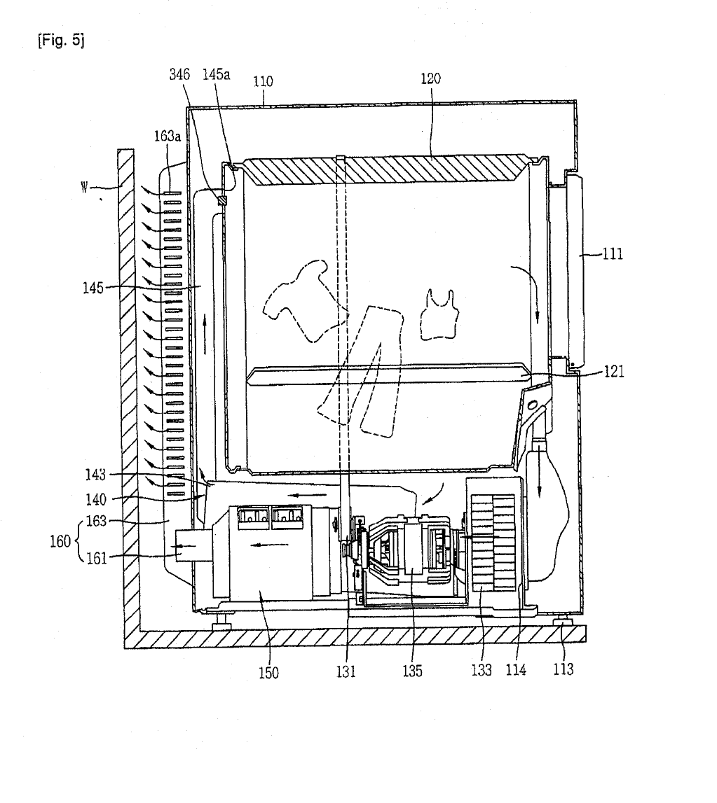

In another embodiment for preventing the hot air generating apparatus from being frequently turned on/off, as shown in FIG. 5, a temperature sensing unit 346 is installed at the connect portion 145a connecting the hot air supply duct 145 with the drum 120.

In case that the air volume in the dryer is reduced, such as lint caught in the filter interrupts flowing of the air, the air cannot facilitate to flow due to too much laundry in the drum, the air volume in the dryer is reduced due to blocking of the duct connected to the outside, since the temperature of the air introduced into the drum 120 is measured to exceed a reference temperature range (i.e., a temperature applied to prevent damage on laundry or a fire) by the temperature sensing unit 364 of FIG. 5, the laundry may be damaged.

To prevent the aforementioned, the hot air supply unit 140 adjusts the gas valve according to the air volume and controls the amount of gas to be supplied to a gas combustor. That is, if a temperature measured by the temperature sensing unit 364 exceeds a reference temperature range resulting from that the air volume is reduced, the gas valve 141 is gradually closed so as to reduce the amount of gas introduced into the gas combustor 143. In order to perform this, preferably, the gas valve is implemented as the solenoid valve by which an injection amount of gas can be minutely controlled.

Accordingly, the amount of heat supplied to the air introduced into the drum 120 can be reduced without frequently stopping the gas combustion so that the temperature of the air can be lowered. Accordingly, it is capable of preventing damage on laundry and of enhancing a stability of the dryer.

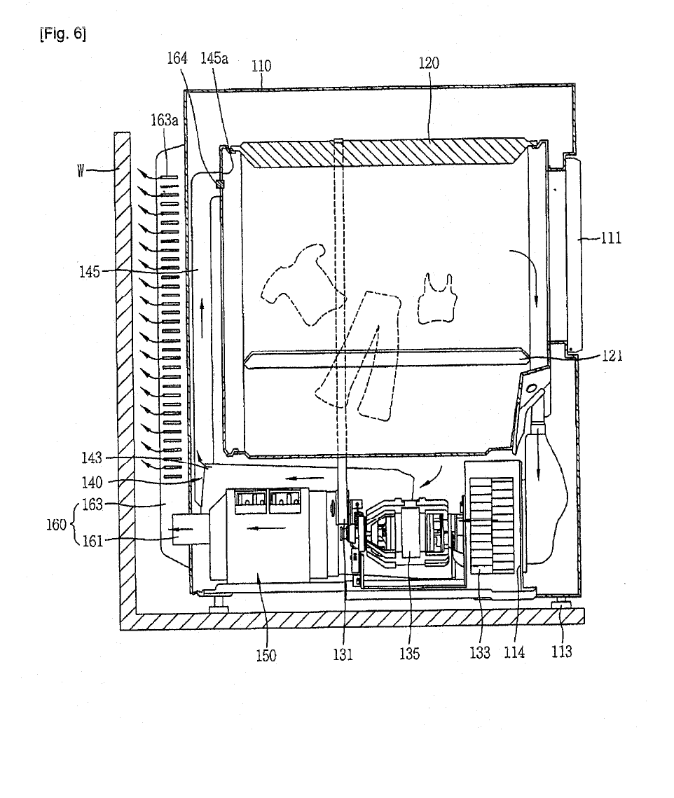

In another embodiment, as shown in FIG. 6, an air volume sensing unit 164 is installed at the connect portion 145a connecting the hot air supply duct 145 with the drum 120 so as to measure an air volume introduced into the drum 120. When air does not facilitates to flow in the dryer and thus the air volume in the dryer is lower than a reference value, the gas valve is gradually closed so as to gradually reduce the amount of gas introduced into the gas combustor.

Accordingly, the amount of heat supplied to the air introduced into the drum 120 can be reduced without frequently stopping the gas combustion so that the temperature of the air can be lowered. Accordingly, it is capable of preventing damage on laundry and of enhancing a stability of the dryer.

In the hot air generating apparatus and the dryer in accordance with the present invention, the temperature of hot air is sensed and the flowing amount of gas to be supplied is controlled based on the sensed temperature using the linear valve, accordingly it is capable of continuously supplying the hot air, thereby being industrially applicable.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. A hot air generating apparatus comprising:
a temperature sensing unit; and
a gas supply unit controlling a flowing amount of gas to be supplied according to a temperature of hot air sensed by the temperature sensing unit, wherein when the temperature of the hot air sensed by the temperature sensing unit approaches a pre-set threshold value, the flowing amount of gas to be supplied is gradually reduced.

2. The apparatus of claim 1, wherein the temperature sensing unit is installed at a funnel encompassing one end of a mixing pipe in which the supplied gas is mixed with air by being connected to the gas supply unit.

3. The apparatus of claim 2, wherein the temperature sensing unit is installed at the funnel so as to be adjacent to an igniter connected to one end of the mixing pipe.

4. The apparatus of claim 1, wherein the temperature sensing unit is implemented as a thermistor.

5. The apparatus of claim 4, wherein the gas supply unit is implemented as a linear valve that can consecutively adjust the gas supply amount.

6. The apparatus of claim 5, wherein the linear valve is implemented as a solenoid.

7. The apparatus of claim 4, further comprises a micom receiving the temperature of the hot air sensed by the temperature sensing unit and controlling the flowing amount of gas to be supplied from the gas supply unit when the temperature approaches the threshold value.

8. A dryer comprising:
a main body;
a drum rotatably installed at the main body;
a hot air generating apparatus for providing hot air into the drum;
a heat exchange unit for removing moisture contained in air exhausted from the drum; and
an exhaust unit dispersively exhausting the air flowing out of the heat exchange unit in a rear direction of the main body,
wherein the hot air generating apparatus comprises a gas supply unit gradually reducing a flowing amount of gas to be supplied when the temperature of the hot air sensed by a temperature sensing unit approaches a threshold value.

9. The dryer of claim 8, wherein the temperature sensing unit is installed at a funnel encompassing one end of a mixing pipe in which the supplied gas is mixed with air by being connected to the gas supply unit.

10. The dryer of claim 8, wherein the temperature sensing unit is installed at a connect portion connecting a hot air supply duct with the drum.

11. A dryer comprising:
a main body;
a drum rotatably installed at the main body;
a hot air generating apparatus for providing hot air into the drum;
a heat exchange unit for removing moisture contained in the air exhausted from the drum; and
an exhaust unit dispersively exhausting the air flowing out of the heat exchange unit in a rear direction of the main body,
wherein the hot air generating apparatus comprises a gas supply unit gradually reducing a flowing amount of gas to be supplied when an air volume sensed by an air volume sensing unit approaches a threshold value.

12. The dryer of claim 11, wherein the air volume sensing unit is installed at a connect portion connecting a hot air supply duct with the drum.

13. The apparatus of claim 2, wherein the temperature sensing unit is implemented as a thermistor.

14. The apparatus of claim 3, wherein the temperature sensing unit is implemented as a thermistor.
